(19) United States
(12) Patent Application Publication
(10) Pub. No.: US 2013/0277875 A1
(43) Pub. Date: Oct. 24, 2013

(54) Method and Apparatus for Producing Carbon Fiber

(71) Applicants: Chong Chen, Broadview Heights, OH (US); James Joseph Pavlisin, Cleveland, OH (US); Brian Paul Askey, Parma Heights, OH (US)

(72) Inventors: Chong Chen, Broadview Heights, OH (US); James Joseph Pavlisin, Cleveland, OH (US); Brian Paul Askey, Parma Heights, OH (US)

(21) Appl. No.: 13/449,896

(22) Filed: Apr. 18, 2012

(51) Int. Cl. B29C 47/00

(52) U.S. Cl. CPC B29C 47/0014
USPC 264/29.2; 425/224; 264/211.1

(57) ABSTRACT

A carbon fiber centrifugal head includes an interior mechanism that at least partially controls flow of precursor material to exterior holes of the head during spinning.

### BACKGROUND

Carbon fibers were first developed in 1958. Since that time, carbon fibers have found use in a wide variety of applications, including, for example, reinforced composite materials, filtration of high-temperature gasses, and additives in graphite electrodes. Due to the continued demand for carbon fibers, there is a need in the art for improved fiber producing methods.

### SUMMARY OF THE EMBODIMENTS

According to one embodiment, a centrifugal spinning head for producing fibers is provided and includes an outer housing that forms an interior volume. The outer housing has an outer shell with a plurality of exterior apertures. An inner screen is positioned inside the interior volume and is spaced from the outer shell to form a gap therebetween. The inner screen includes a plurality of interior apertures. A fiber precursor material is received in the interior volume, and upon spinning the head, flows through the interior apertures, into the gap and thereafter through the exterior apertures.

According to another embodiment, a method of producing carbon fibers includes providing a head having an outer housing that forms an interior volume and includes a plurality of exterior apertures. The head further including a screen positioned with the interior volume. A gap is formed between the outer housing and screen. Fiber precursor material is added into the interior volume. The head is spun and the fiber precursor material is heated to a temperature above the softening point of the fiber precursor material. The flow of the fiber precursor material out of the exterior apertures is controlled by controlling the size of the gap. The fibers are captured after being ejected from the exterior apertures. The fibers are thereafter stabilized and carbonized.

### BRIEF DESCRIPTION OF THE DRAWINGS

FIG. 1 is a side elevated view of a spinning head.

FIG. 2 is a sectional view taken along the line A-A of FIG. 1.

FIG. 3 is a sectional view taken along the line B-B of FIG. 1.

FIG. 4 is a partially schematic view of a centrifugal spinning apparatus.

### DETAILED DESCRIPTION

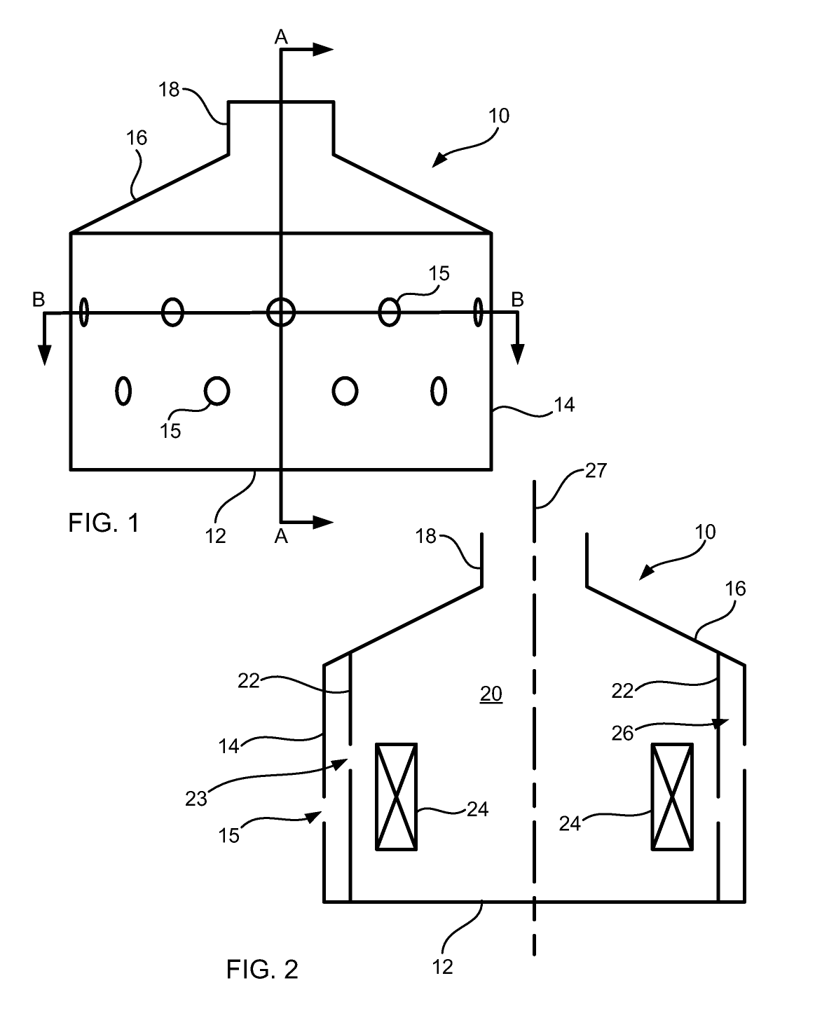

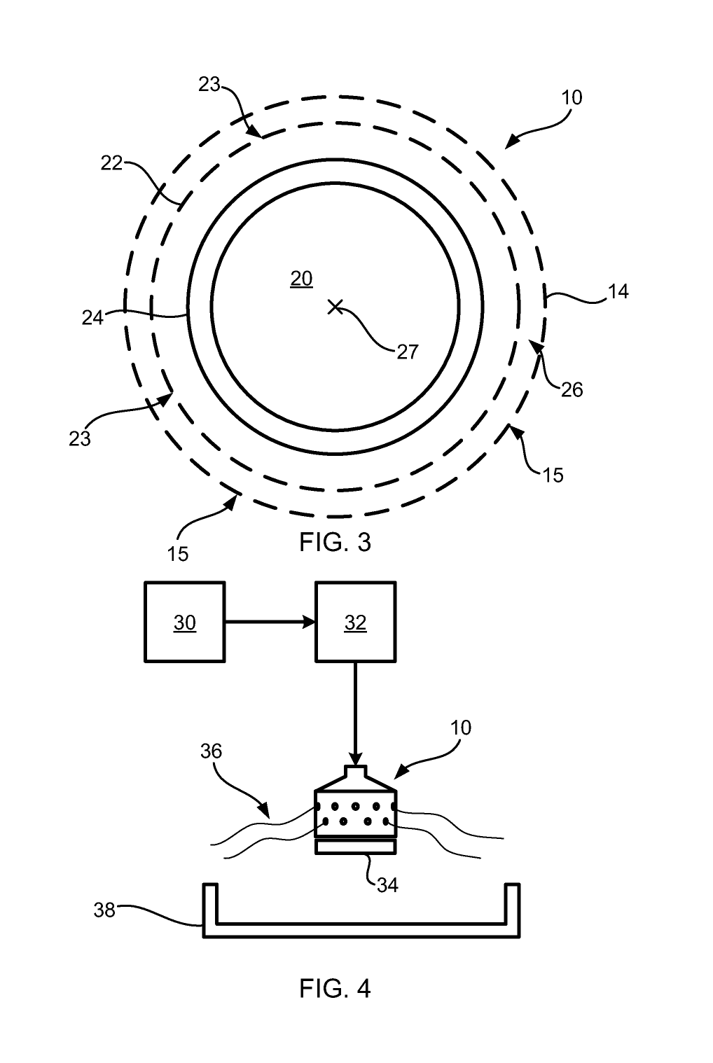

With reference now to FIGS. 1-3, a fiber spinning head is shown and generally indicated by the numeral 10. Head 10 has an outer housing including a bottom wall 12, a generally cylindrical outer shell 14 and a tapered frusto-conical section 16 extending inwardly and upwardly from the top edge of shell 14. The frusto-conical section 16 terminates at a top opening 18. Top opening 18 provides access to an interior volume 20 of the head 10.

Outer shell 14 includes a plurality of apertures 15 which may be randomly arranged or uniformly arranged or a combination thereof around outer shell 14. In this or other embodiments, the apertures 15 may be circumferentially spaced around outer shell 14. Apertures 15 may be positioned in one or more vertically spaced circumferential rows which may be aligned or offset. Advantageously, apertures 15 may have a diameter of from about 0.5 mm to about 5 mm. More advantageously, apertures 15 may have a diameter of from about 1 mm to about 2 mm.

Positioned inside of interior volume 20 and radially inwardly of the outer shell 14 is an interior screen 22. Optionally, a heating element 24 may be positioned within interior volume 20 and inwardly of the interior screen 22. Interior screen 22 extends circumferentially around the entire interior 20 of head 10 and includes a plurality of apertures 23 which may be randomly or uniformly arranged or circumferentially spaced around interior screen 22. In this or other embodiments, apertures 23 may be positioned in one or more vertically spaced circumferential rows which may be aligned or offset. Advantageously, apertures 23 may have a diameter of from about 0.5 mm to about 5 mm. More advantageously, apertures 23 may have a diameter of from about 1 mm to about 2 mm. In a preferred embodiment, substantially all apertures 23 are unaligned with apertures 15. In a particularly preferred embodiment, none of apertures 23 are aligned with apertures 15.

The total area of the interior apertures is defined herein as the average area of the interior apertures times the number of interior apertures. Likewise, the total area of the exterior apertures is defined herein as the average area of the exterior apertures times the number of exterior apertures. The ratio of the total area of the interior apertures divided by the total area of the exterior apertures (“interior area to exterior area ratio”) may affect the flow rate of the precursor material out of head 10. The interior area to exterior area ratio may be from about 0.1 to about 100. The interior area to exterior area ratio may be further advantageously from about 0.5 to about 10. The interior area to exterior area ratio may further be advantageously from between 0.5 to about 5.

A gap 26 is formed between the outer shell 14 and interior screen 22. The gap size in particular affects the flow rate of precursor out of apertures 23 during spinning of the head 10. The gap 26 may be from about 0.025 mm to about 2 mm. Advantageously, gap 26 is from about 0.075 mm to about 0.5 mm. Gap 26 may be maintained by one or more spacers (not shown) positioned between interior screen and exterior shell.

In use, fiber precursor material is charged into the interior volume 20 of head 10 through opening 18. In one embodiment, the precursor material may be preheated prior to insertion into the head 10. In this or other embodiments, the heating element 24 may heat the precursor material while inside the interior volume 20 of the head 10.

Once charged with precursor material, head 10 may be rotated about axis 27. This rotation causes centrifugal forces that in turn cause the precursor material to be drawn radially outwardly against interior screen 22.

As head 10 spins, precursor material flows into the gap 26 via apertures 23 and thereafter flows out of apertures 15 of the outer shell 14. As precursor material is expelled out of apertures 15, it solidifies or hardens in the air and falls to a receptacle in the form of a fiber.

The fiber creation process may be batch, wherein the head 10 is charged and spun until the precursor material within is exhausted. Alternately, the process may be continuous. For example, with reference to FIG. 4, a precursor supply 30 may carry a supply of precursor material therein. The precursor may be fed through an optional heating element 32 and thereafter into head 10, which is spinning on a platform 34. The fibers 36 are continuously ejected from head 10 and thereafter collected in a receptacle 38 for additional processing.

In one particular preferred embodiment, the precursor material is a pitch material. Pitch material may be a coal tar pitch or petroleum pitch. Advantageously, the head 10 enables precursor pitches having a Quinoline-Insoluable value (hereinafter QI) of from between 0 and 50 percent by weight. In other embodiments, the QI value of the precursor pitch is greater than 1 percent by weight. In still other embodiments the QI value of the precursor pitch is greater than 5 percent by weight. In still other embodiments the QI value of the precursor pitch is greater than 10 percent by weight. In still other embodiments the QI value of the precursor pitch is from between 5 and 25 percent by weight. In other embodiments, the QI value of the precursor pitch is from between 10 and 20 percent by weight.

Precursor pitch may have softening points between about 90 degrees and 350 degrees C. Advantageously, precursor pitch has a softening point between about 150 degrees and about 330 degrees C. More advantageously, the precursor pitch has a softening point between about 200 degrees and about 330 degrees C.

Precursor pitch may have coking values between about 30% and about 95%. Advantageously the precursor pitch has a coking value between about 70% and 95%. Even more advantageously, the precursor pitch has a coking value between about 80% and about 95%.

After formation using the head 10, the fibers are stabilized by heating in an air atmosphere at a temperature of from about 30 to about 350 degrees C. for a period of from about 5 to about 600 minutes. After stabilization, the fibers are carbonized in an inert atmosphere at a temperature of from about 800 to about 1500 degrees C. for a period of from about one to about five hours.

### Example 1

A cylindrical head included an interior screen having apertures with a diameter of 3 mm and with apertures through the outer shell with a diameter of 1.1 mm. A spacer was positioned between the interior screen and outer shell to maintain a gap therebetween of 0.1 mm. A total of 15 apertures were provided through the interior screen and 100 apertures were provided through the outer shell giving a ratio of inner aperture area to outer aperture area of 1.1.

A coal tar pitch precursor material with a softening point of 220 degrees C., a carbon yield of greater or equal to 80% and a QI of 11 wt % was charged into the head. The precursor was in powder form and added to the head without any preheating and while the head was stationary. The head was simultaneously spun and heated. The head spun at approximately 4000 RPM and the heater was maintained at from 280-350 degrees C. The spun fibers were collected in a receiving bowel.

Thereafter, the spun fibers were stabilized and carbonized. The resultant carbon fiber was of good quality and isotropic in texture, implying good insulation properties. The fiber diameter had a distribution of from 10 to 20 μm.

It should be appreciated that, though the above describes the fiber precursor as a pitch material, other precursor materials may be used with the above centrifugal spinning head. For example, precursors such as lignin, polymers and blends thereof may be used. So long as the precursor material has sufficient viscosity and is capable of stabilization, the precursor material may be used in the above described centrifugal spinning apparatus.

The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed:

1. A centrifugal spinning head for producing fibers comprising:
an outer housing that forms an interior volume, the outer housing having an outer shell with a plurality of exterior apertures;
an inner screen positioned inside said interior volume and spaced from the outer shell to form a gap therebetween, the inner screen including a plurality of interior apertures; and
wherein a fiber precursor material is received in said interior volume, and upon spinning the head, flows through the interior apertures, into the gap and thereafter through the exterior apertures.

2. The centrifugal spinning head of claim 1 further comprising a heating element positioned within the interior volume.

3. The centrifugal spinning head of claim 1 wherein the outer shell is generally cylindrical.

4. The centrifugal spinning head of claim 1 wherein the inner screen extends the around the entire circumference of the interior volume.

5. The centrifugal spinning head of claim 1 wherein the ratio of the total area of the plurality of interior apertures divided by the total area of the plurality of exterior apertures is from about 0.1 to about 100.

6. The centrifugal spinning head of claim 1 wherein the ratio of the total area of the plurality of interior apertures divided by the total area of the plurality of exterior apertures is from between about 0.5 to about 10.

7. The centrifugal spinning head of claim 1 wherein the plurality of exterior apertures have a diameter of from about 0.5 to about 5 millimeters.

8. The centrifugal spinning head of claim 7 wherein the plurality of exterior apertures have a diameter of from about 1 to about 2 millimeters.

9. The centrifugal spinning head of claim 1 wherein the plurality of interior apertures have a diameter of from about 0.5 to about 5 millimeters.

10. The centrifugal spinning head of claim 7 wherein the plurality of interior apertures have a diameter of from about 1 to about 2 millimeters.

11. The centrifugal spinning head of claim 1 wherein the gap is from between about 0.025 mm to about 2 mm.

12. The centrifugal spinning head of claim 11 wherein the gap is from between about 0.075 mm to about 0.5 mm.

13. The centrifugal spinning head of claim 1 wherein substantially all of said interior apertures are unaligned with substantially all of said exterior apertures.

14. A method of producing carbon fibers comprising:
providing a head having an outer housing that forms an interior volume and includes a plurality of exterior apertures, a screen being positioned with the interior volume, a gap being formed between the outer housing and screen;
charging fiber precursor material into the interior volume;
spinning the head;
heating the fiber precursor material to a temperature above the softening point of the fiber precursor material;
controlling the flow of the fiber precursor material out of the exterior apertures by controlling the size of the gap; and
capturing the fibers that are ejected from the exterior apertures.

15. The method of claim 14 wherein said fiber precursor material is coal tar pitch.

16. The method of claim 14 wherein said fiber precursor material has a QI value of from about 0 to about 50.

17. The method of claim 16 wherein the fiber precursor material has a QI value of from about 5 to about 25 percent.

18. The method of claim 16 wherein the head further comprises an inner screen positioned inside said interior volume and spaced from the outer shell to form a gap therebetween, the inner screen including a plurality of interior apertures.

19. The method of claim 14 wherein the coking value of the fiber precursor material is greater than about 50%.

20. The method of claim 19 wherein the coking value of the fiber precursor material is greater than about 70%.

21. The method of claim 19 wherein the coking value of the fiber precursor material is greater than about 85%.

22. The method of claim 14 further comprising stabilizing the fibers.

23. The method of claim 22 further comprising carbonizing the fibers.
